(19) United States
(12) Patent Application Publication
(10) Pub. No.: US 2020/0359357 A1
(43) Pub. Date: Nov. 12, 2020

(54) USER DEVICE

(71) Applicant: NTT DOCOMO, INC., Tokyo (JP)

(72) Inventors: Shinpei Yasukawa, Chiyoda-ku, Tokyo (JP); Satoshi Nagata, Chiyoda-ku, Tokyo (JP); Huan Wang, Beijing (CN); Xiaolin Hou, Beijing (CN)

(73) Assignee: NTT DOCOMO, INC., Tokyo (JP)

(21) Appl. No.: 16/762,013

(22) PCT Filed: Nov. 13, 2017
(86) PCT No.: PCT/JP2017/040750

§ 371 Date: May 6, 2020

(51) Int. Cl. H04W 72/02; H04W 72/04; H04B 7/06; H04W 16/28

(52) U.S. Cl. CPC H04W 72/02; H04W 72/046; H04W 92/18; H04W 16/28; H04B 7/0617

(57) ABSTRACT

A user device performs communication in which beamforming is applied with another user device, and has a reception unit that receives information related to a region covered by a beam with respect to a certain resource from another user device, a selection unit that selects the resource based on information representing the region covered by the beam, and a transmission unit configured to perform transmission by using the selected resource.

### TECHNICAL FIELD

The present invention relates to a user device in a radio communication system.

### BACKGROUND ART

In LTE (Long Term Evolution) and the successor system of LTE (for example, as LTE-A (LTE Advanced) and NR (New Radio) (which is also called 5G)), D2D (Device to Device) technology has been studied, in which user devices directly communicate with each other without going through a radio base station.

D2D enables reduction in traffic between a user device and a base station apparatus, and allows communication between the user devices even if the base station apparatus becomes unable to communicate at the time of disaster or the like.

D2D is roughly classified into D2D discovery (D2D discovery, which is also referred to as D2D detection) for finding another user terminal with which communication is possible, and D2D communication (D2D direct communication, which is also referred to as D2D communication, inter-terminal direct communication, and the like) for directly communicating between terminals. In the following, when D2D communication, D2D discovery, and the like are not particularly distinguished, they are simply referred to as D2D. Furthermore, signals transmitted and received in D2D are referred to as D2D signals.

It is noted in 3GPP (3rd Generation Partnership Project) that D2D is referred to as “sidelink (sidelink)”. However, the term of D2D is used in the present specification as a more general term. When need arises, sidelink will be used in the description of embodiments disclosed below.

Also, in 3GPP, it is studied to realize V2X (Vehicle to Everything) or eV2X (enhanced V2X) by extending the above-described D2D functions, so that their specification development is in progress. V2X described herein is a part of ITS (Intelligent Transport Systems), and is a common term for V2V (Vehicle to Vehicle) that means a communication mode performed between automobiles, V2I (Vehicle to Infrastructure) that means a communication mode performed between an automobile and a road-side unit (RSU: Road-Side Unit) installed at a road side, V2N (Vehicle to Nomadic device) that means a communication mode performed between an automobile and a mobile terminal of a driver, and V2P (Vehicle to Pedestrian) that means a communication mode performed between an automobile and a mobile terminal of a pedestrian.

In LTE Release 14, a specification has been developed in relation to several functions of V2X (for example, Non-Patent Document 1). In this specification, Mode3 and Mode4 are defined in relation to allocating a resource to a user device for V2X communication. In Mode3, a transmission resource is allocated dynamically by DCI (Downlink Control Information) sent from the base station apparatus to the user device. Also, SPS (Semi Persistent Scheduling) is possible in Mode3. In Mode4, a user device selects a transmission resource autonomously from a resource pool.

In D2D in NR, it is intended to use frequencies of a broad band from a low frequency band as low as LTE to a high frequency band (millimeter wave band) still higher than LTE. In particular, a propagation loss increases in a high frequency band. It has been considered to apply beamforming with a small beam width to compensate for this propagation loss.

### PRIOR ART DOCUMENT

### Non-Patent Document

Non-Patent Document 1: 3GPP TS 36.213 V14.3.0 (2017-06)
Non-Patent Document 2: 3GPP TS 36.211 V14.3.0 (2017-06)

### SUMMARY OF THE INVENTION

### Problem to be Solved by the Invention

In D2D, if a transmission side user device applies beamforming, received power of the beam decreases in a reception side user device in a direction in which this beam is not directed. However, it is likely in the reception side user device that an actually usable resource may be eliminated from usable resources after determining that even a resource located in a direction in which the beam from the transmission side user device is not directed is in a transmission range of the transmission side user device. A problem is that resource utilization efficiency decreases.

The present invention is achieved in view of the above problem. An object of the present invention is to improve resource utilization efficiency in a user device which performs transmission by applying beamforming in D2D.

### Means for Solving the Problem

According to the disclosed technique, a user device that performs communication in which beamforming is applied with another user device is provided, including a reception unit that receives information related to a region covered by a beam with respect to a certain resource from another user device, a selection unit that selects the resource based on information representing the region covered by the beam, and a transmission unit that performs transmission by using the selected resource.

### Advantage of the Invention

According to the disclosed technique, it is possible to improve resource utilization efficiency in a user device which performs transmission by applying beamforming in D2D.

### BRIEF DESCRIPTION OF DRAWINGS

FIG. 1A is a view illustrating an example of configuring an antenna incorporated in a user device 100.

FIG. 1B is a view illustrating an example of performing transmission by applying different beams in time division in the user device 100.

FIG. 1C is a view illustrating a transmission range of the user device 100.

FIG. 2 is a view illustrating an example of a beam transmitted by the user device 100.

FIG. 3 is a view illustrating an example of sensing operation in the user device 100.

FIG. 4 is a view illustrating an example (1) of resource selection in the user device 100.

FIG. 5 is a view illustrating an example (2) of resource selection in the user device 100.

FIG. 6 is a view illustrating an example of resource selection in the embodiment of the present invention.

FIG. 7 is a view for describing a beam coverage area in the embodiment of the present invention.

FIG. 8 is a flowchart illustrating the example (1) of resource selection in the embodiment of the present invention.

FIG. 9 is a flowchart illustrating the example (2) of resource selection in the embodiment of the present invention.

FIG. 10 is a flowchart illustrating the example (3) of resource selection in the embodiment of the present invention.

FIG. 11 is a view illustrating reception of a beam in the user device 100 in the embodiment of the present invention.

FIG. 12 is a view illustrating an example of an antenna setting in the user device 100 in the embodiment of the present invention.

FIG. 13 is a view illustrating an example of configuring functions in the user device 100.

FIG. 14 is a view illustrating an example of hardware configuration of the user device 100.

### EMBODIMENTS OF THE INVENTION

An embodiment of the present invention is described below by referring to the drawings. Note that the embodiment described below is only an example, and the embodiment to which the present invention is applied is not limited to the following embodiment.

For the operation of a wireless communication system of the present embodiment, existing techniques are used suitably. However, those existing techniques are, for example, existing LTE, but are not limited to existing LTE. The term “LTE” used in the present specification should be read to have a broad meaning inclusive of LTE-Advanced and systems later than LTE-Advanced (for example, NR), unless otherwise mentioned.

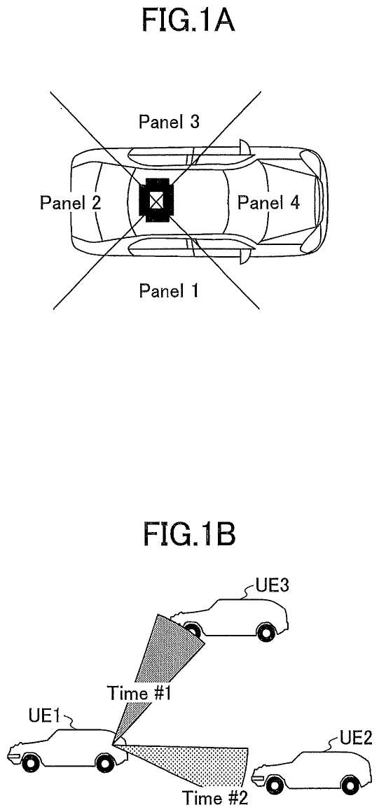

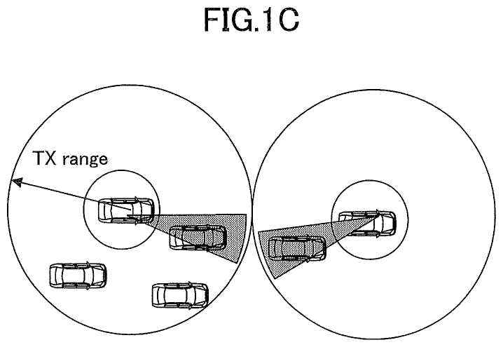

FIG. 1 are views illustrating configuration examples of a radio communication system in the embodiment of the present invention. As illustrated in FIG. 1B or 1C, the radio communication system in the embodiment of the present invention includes a plurality of user devices 100. Three of the user devices 100 are illustrated in FIG. 1B, but are only an example, and can be in a larger number. Hereinafter, the user device 100 is also referred to as “UE (user equipment)”. The user device 100 is a communication device having a radio communication function, such as a vehicle-mounted communication device, smart phone, cellular phone, tablet, wearable terminal, M2M (Machine-to-Machine) communication module and the like. The user device 100 uses various communication services which wirelessly connect with a base station apparatus or the user device 100, and are provided by a radio communication system. The user device 100 can perform beamforming to transmit and receive signals. In the embodiment of the present invention, communication in use with a millimeter wave band is mainly intended in a vehicle-mounted communication device in V2X.

In the embodiment of the present invention, duplex systems may be TDD (Time Division Duplex) system, FDD (Frequency Division Duplex) system, or others (for example, Flexible Duplex or the like). In the description below, transmitting a signal with a transmission beam may be transmission of a signal multiplied by a precoding vector (precoded by the precoding vector). Similarly, receiving a signal with a reception beam may be multiplication of a received signal by a predetermined weight vector. Also, transmitting a signal with a transmission beam may be expressed as transmission of the signal through a particular antenna port. Similarly, receiving a signal with a reception beam may be expressed as reception of the signal through a particular antenna port. The term of antenna port means a logical antenna port as defined in 3GPP standards or a physical antenna port. Methods of forming a transmission beam and reception beam are not limited to those methods described above. For example, a method of changing an angle of each antenna in the user device 100 having plural antennas may be applied. A method of combining a method of using a precoding vector and a method of changing the angle of the antenna may be applied. Different antenna panels may be switched and utilized. A method of combining methods of using plural combined antenna panels may be applied. Other methods may be applied. Also, plural transmission beams different from one another may be used in, for example, a high frequency band. Using plural transmission beams is referred to as multi-beam operation. Using a single transmission beam is referred to as single beam operation.

FIG. 1A is a view illustrating a configuration example of an antenna incorporated in the user device 100. Antenna panels from Panel1 to Panel4 are incorporated respectively in directions to the front and rear and to the right and left on the vehicle, to function as the transmission/reception antenna in the millimeter wave band.

FIG. 1B is a view illustrating an example in which the user device 100 performs transmission by applying different beams by time sharing. This is an example of beam switching in which, at the time of Time #1, a beam directed to UE3 is transmitted, and at the time of Time #2, a beam directed to UE2 is transmitted.

FIG. 1C is a view illustrating a transmission range of the user device 100. In the drawing, the range designated as “TX range” is the transmission range targeted by V2X in the present embodiment. The same transmission range is, for example, intended to be within a radius of several hundreds of meters or so about the center at a vehicle.

### Embodiment 1

Embodiment 1 will be described hereinafter.

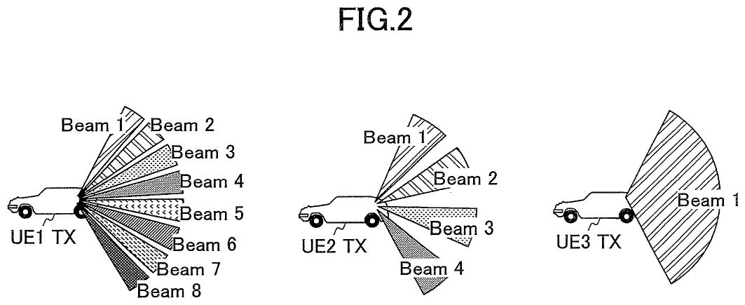

FIG. 2 is a view illustrating an example of a beam to be transmitted by the user device 100. In the embodiment of the present invention, it is intended that the user device 100 performs the communication in the millimeter wave band.

Transmission by beam switching of a beam at unit time may be performed, or repeated transmission of a beam may be performed. As defined in 3GPP Release 14, it is intended in the user device 100 that autonomous resource selection is performed on the basis of sensing a resource, so as to enable background sensing and establishment of a transmission resource. Also, transmission by use of beamforming is intended in the user device 100. Beams with different beam widths are used for realizing different transmission ranges. In communication of the millimeter wave band, it is possible to reduce an antenna size, so communication by use of MIMO (multiple-input and multiple-output) is intended.

As illustrated in FIG. 2, UE1 is an example of the user device 100 that transmits eight beams from Beam1 to Beam8. UE2 is an example of the user device 100 that transmits four beams from Beam1 to Beam4. UE3 is an example of the user device 100 that transmits Beam1.

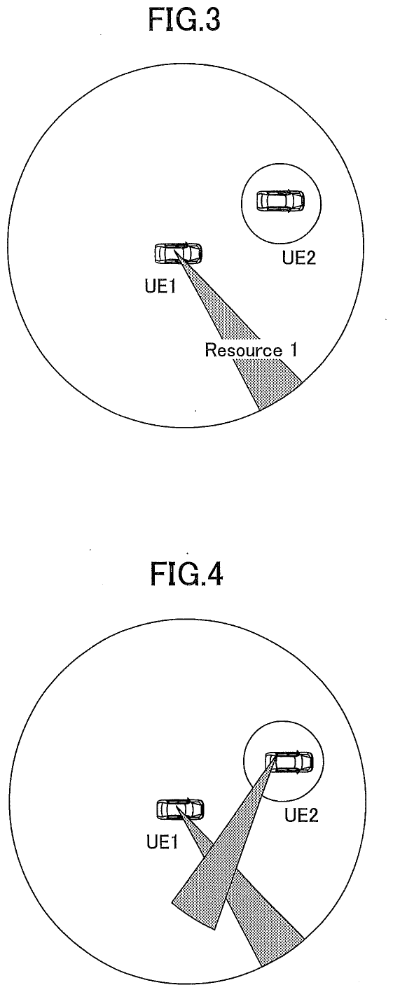

FIG. 3 is a view illustrating an example of sensing operation in the user device 100. The resource selection in the user device 100 is performed based on a result of sensing the millimeter wave band as defined in 3GPP Release 14. While the user device 100 performs the resource selection, a resource used by another closely located user device 100 is eliminated from a target of the selection in order to avoid collision of resources. It is noted that the resource selection may be performing selection according to the time region and frequency region, or performing selection only in the time region in consideration of the in-band interference, or performing selection only in the frequency region for reducing a delay. The resource selection according to the embodiment of the present invention can be any resource selection as target, through use of plural measurement results without limitation to sensing in 3GPP Release 14.

If the user device 100 transmits a beam having a small beam width, it is likely that a used resource may be eliminated thereby lowering the spatial reuse efficiency of the resource even though the used resource is usable by another closely located user device 100. In the present embodiment, selection or elimination of a resource on the basis of a beam coverage area in consideration of a beam direction will be described later for realizing high spatial reuse efficiency.

UE1 illustrated in FIG. 3 occupies Resource1 and transmits a beam. As UE2 is within the transmission range of UE1 designated by the outer circle in the drawing, there is possibility of eliminating Resource1 at the time of performing the resource selection. Thus, the spatial reuse efficiency of the resources decreases. In view of this, a method is intended, in which a resource in a direction in which UE1 does not direct the beam is prevented from elimination in the resource selection in UE2.

FIG. 4 is a view illustrating an example (1) of resource selection by the user device 100. An example is described, in which the user device 100 in FIG. 4 always performs the resource selection at random without sensing.

UE2 illustrated in FIG. 4 selects a resource randomly without sensing, when a beam has a particular width and index. Thus, collision between resources occurs when the UE1 uses the same resource. Upon selecting a resource randomly without sensing, it is assumed that collision of resources frequently occurs between the user devices 100 located closely to one another. The indexes of the beams are from 1 to 8, from “Beam1” to “Beam8” illustrated in FIG. 2.

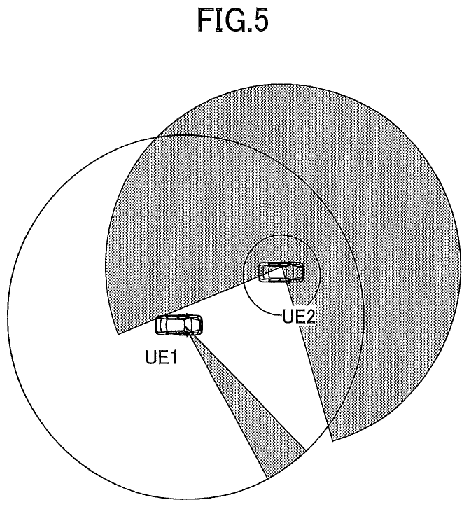

FIG. 5 is a view illustrating an example (2) of resource selection by the user device 100. An example is described, in which the user device 100 in FIG. 5 reuses a resource occupied by another closely located user devices 100.

UE2 illustrated in FIG. 5 performs transmission by reusing the resource occupied by UE1 to a destination different from the destination of UE1. When transmission ranges of UE1 and UE2 do not overlap with one another, UE1 and UE2 can use the same resource. To use the same resource, it is necessary to share the following information between the user devices 100 arranged closely to each other.

1. Location information

2. Information representing a time region and a frequency region of the occupied resource

3. Direction of a beam transmitted at the occupied resource

The location information is location information of each user device 100. The resource is identified according to information representing the time region and frequency region of the occupied resource. A direction of a beam to be transmitted at the occupied resource may be identified according to, for example, ID of the transmission source user device 100 (source ID) and ID of the transmission destination user device 100 (destination ID).

The user device 100 can create an interference map based on the above-described shared information and results of sensing. The interference map represents location information, occupied resource and a direction of the beam of transmission for each user device 100 closely disposed. The user device 100 can select a resource and transmission path without interference with other transmission on the basis of the interference map.

In the above example, some problems are anticipated, such as possibility in incorrectness in the location information, occurrence of an extremely large signaling overhead with information shared between respectively closely arranged user devices 100, and dynamic changes in the interference map.

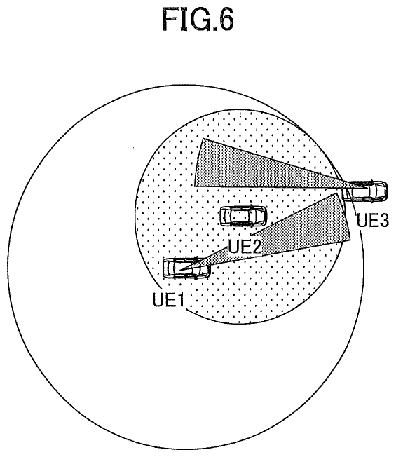

FIG. 6 is a view illustrating an example of resource selection in the embodiment of the present invention. A method of improving both of the spatial reuse efficiency and mitigation of collision of resources will be hereinafter described.

The user device 100 eliminates a resource at the time of the resource selection on the basis of the measured RSRP (Reference Signal Received Power) and the beam coverage area.

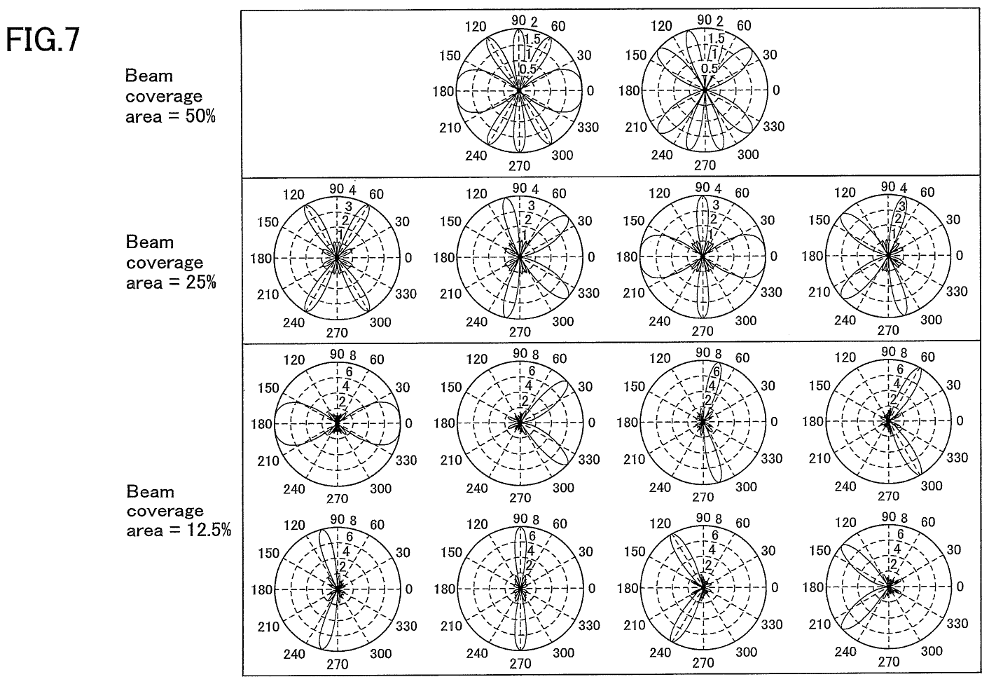

FIG. 7 is a view in order to describe a beam coverage area in the embodiment of the present invention. The beam coverage area in a certain occupied resource is defined by a ratio between a region covered by the predetermined transmission beam and the entire region coverable by the transmission side user device 100. For example, the beam coverage area is an angular space of transmission within X dB from a peak level (gain in the main beam direction).

FIG. 7 illustrates regions covered by a transmission beam for respective conditions of a beam coverage area 50%, a beam coverage area 25%, and a beam coverage area 12.5%. When the beam coverage area is 50%, a region covered by the transmission beam is 50% of the entire region coverable by the transmission side user device 100. Similarly, when the beam coverage area is 25%, a region covered by the transmission beam is 25% of the entire region coverable by the transmission side user device 100. Similarly, when the beam coverage area is 12.5%, a region covered by the transmission beam is 12.5% of the entire region coverable by the transmission side user device 100. Table 1 below refers to an example in which indexes are assigned to the beam coverage areas.

TABLE 1

| Index | Beam coverage area |
|---|---|
| 1 | 100% |
| 2 | 50% |
| 3 | 25% |
| 4 | 12.5% |

As indicated in Table 1, “1” corresponds to the beam coverage area 100%, “2” corresponds to the beam coverage area 50%, “3” corresponds to the beam coverage area 25%, and “4” corresponds to the beam coverage area 12.5%. The values of the beam coverage areas may not be limited to ratio values with correctness, but may be estimated values, and also can be determined values different from those in Table 1, for example, 60%, 40%, 33% and the like. Also, indexes corresponding to the beam coverage areas can be determined to be, for example, 10 indexes with a step of 10% from 100% to 0%.

Also, the beam coverage areas may be replaced with patterns of the beam, indexes of the precoder, matrices of the precoder or the like. Specifically, indexes can be assigned to the patterns of the beam, indexes of the precoder, matrices of the precoder or the like, and can be treated similarly to the indexes assigned to the beam coverage areas.

Referring back to FIG. 6, when the user device 100 receives RSRPs of a similar level in sensing of certain resources, according to the beam coverage area, if a beam with a smaller width is transmitted by another user device 100, then possibility of eliminating the corresponding resource is decreased. Specifically, a threshold value for RSRP is determined higher for the resource occupied with the beam with the smaller width at the time of resource selection at the user device 100 performing sensing. For example, if there are two resource candidates with the same RSRP, a resource with a larger beam width of a transmission beam is eliminated, so that probability in enabling selection of a resource with a lower interference level can become higher in a peripheral user device.

As the resource selection based on the beam coverage area is performed as described above, the user device 100 notifies a closely located user device 100 of a beam coverage area or an index denoting the beam coverage area. The beam coverage area and the index denoting the beam coverage area are predetermined as described with FIG. 7. Notification of the beam coverage area may be performed by PHY layer signaling, may be performed by signaling of MAC (Medium Access Control) CE (Control Element), or may be performed by RRC (Radio Resource Control) signaling. This signaling can be executed together with explicit occupation of a resource or with information representing priority of the resource.

It is noted that signaling in the D2D communication may be included in a control signal related to reception in a case of the same reception having been successful formerly, or may be obtained by decoding the resource at the time of sensing.

Examples of references for eliminating a resource at the time of resource selection of the user device 100 are the following three.

Opt.1. Threshold value of a beam coverage area

Opt.2. Corrected threshold value of RSRP by a beam coverage area

Opt.3. Threshold value of a beam coverage area, and corrected threshold value of RSRP by the beam coverage area

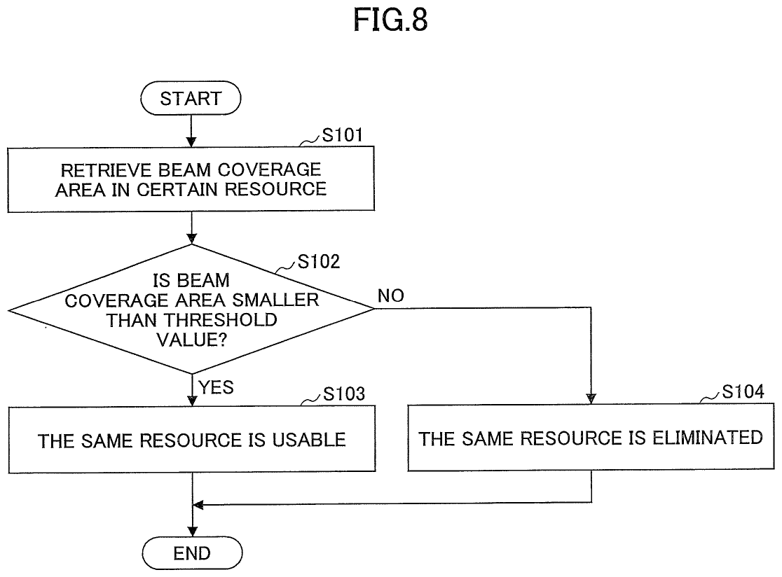

FIG. 8 is a flowchart illustrating an example (1) of resource selection in the embodiment of the present invention. FIG. 8 is a flowchart corresponding to Opt.1 described with FIG. 6. In Opt.1, the user device 100 determines whether a certain resource should be eliminated based on the beam coverage area obtained from another user device 100 in relation to the same resource.

In a step S101, the user device 100 obtains a beam coverage area in a certain resource from the other closely located user device 100. The beam coverage area may be notified by use of an index of the beam coverage area indicated in Table 1.

In a succeeding step S102, the user device 100 determines whether the beam coverage area is smaller than a threshold value. The threshold value for determination of the beam coverage area may be determined or predetermined.

If the beam coverage area is smaller than the threshold value (yes in S102), the flow proceeds to a step S103. The same resource is made usable. If the beam coverage area is equal to or larger than the threshold value, the flow proceeds to a step S104. The same resource is eliminated.

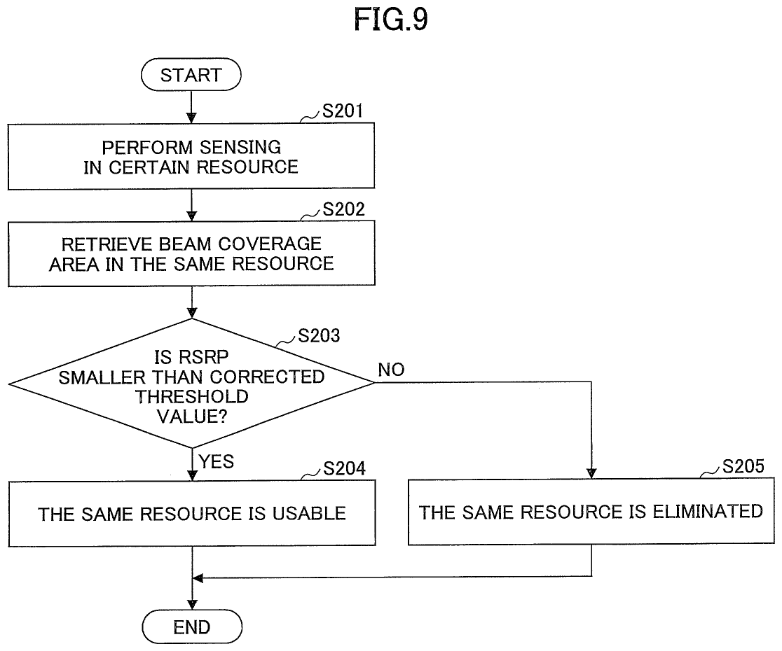

FIG. 9 is a flowchart illustrating an example (2) of resource selection in the embodiment of the present invention. FIG. 9 is a flowchart corresponding to Opt.2 described with FIG. 6. In Opt.2, the user device 100 determines whether a certain resource should be eliminated based on a corrected threshold value of RSRP corrected on the basis of the beam coverage area obtained from another user device 100 in relation to the same resource.

In a step S201, the user device 100 performs sensing in a certain resource.

In a succeeding step S202, the user device 100 obtains a beam coverage area in a certain resource from another closely located user device 100. The beam coverage area may be transmitted with an index of the beam coverage area indicated in Table 1.

In the succeeding step S203, the user device 100 determines whether RSRP of the same resource is smaller than the corrected threshold value.

If RSRP is smaller than the corrected threshold value (yes in S203), the flow proceeds to a step S204. The same resource is made usable. If RSRP is equal to or larger than the corrected threshold value, the flow proceeds to a step S205. The same resource is eliminated.

Table 2 below indicates the example of correcting the threshold value of RSRP on the basis of the beam coverage area.

TABLE 2

| Beam | | Beam | |
|---|---|---|---|
| coverage | | coverage | RSRP |
| area of | RSRP | area of | deduction |
| sensing | deduction | potential | stepsize |
| resource | factor k | transmission | ΔT/dB |
| 0-10% | 0 | 0-10% | 0 |
| 10-20% | 1 | 10-20% | 1 |
| 20-30% | 2 | 20-30% | 2 |
| 30-40% | 3 | 30-40% | 3 |
| 40-50% | 4 | 40-50% | 4 |

The “Beam coverage area of sensing resource” indicated in Table 2 is a beam coverage area to be sensed by the user device 100. The “RSRP deduction factor k” is a factor for decreasing the threshold value.

The “Beam coverage area of potential transmission” indicated in Table 2 is a beam coverage area of a beam to be transmitted by the user device 100. The “RSRP deduction stepsize ΔT/dB” is a stepsize ΔT [dB] of decreasing the threshold value.

The corrected threshold value TC is expressed as TC=T100%−k*ΔT. T100% is the threshold value before the correction and predetermined. Assuming that k=0 or ΔT=0, the processing is performed in the same manner as elimination of a resource based on the RSRP measurement in 3GPP Release 14.

In case the correction of the threshold value of RSRP is performed based on Table 2, a certain resource can be the more easily eliminated in the user device 100 performing sensing according to greatness in the width of a beam which another user device 100 transmits in the same resource. In case the correction of the threshold value of RSRP is performed based on Table 2, a certain resource can be made more difficult to eliminate in the user device 100 performing sensing according to narrowness of the width of a beam which the user device 100 intends to transmit in the same resource.

Also, it is possible to set the “RSRP deduction stepsize ΔT/dB” to be larger according to, for example, the smallness of a coverage area of a beam to be transmitted by the user device 100, unlike Table 2. In this mode, a certain resource can be made more difficult to eliminate in the user device 100 according to greatness in the width of a beam which the user device 100 sensing the same resource intends to transmit.

Also, it is possible to set the “RSRP deduction stepsize ΔT/dB” equal to, for example, a constant value unlike Table 2. In this mode, irrespective of a beam to be transmitted by the user device 100 performing sensing, a certain resource can be made easier to eliminate in the user device 100 performing sensing, according to narrowness in the width of a beam which another user device 100 transmits in the same resource.

As described above, it is possible to determine or predetermine correcting of a threshold value of RSRP in the resource to be sensed according to the beam width of a beam transmitted by another user device 100. Also, it is possible to determine or predetermine correcting of a threshold value of RSRP in the resource to be sensed according to the beam width to which the user device 100 gives priority at the time of transmission.

The “RSRP deduction stepsize ΔT/dB” may be determined according to the transmission beam index or transmission beam coverage, or may be predetermined. The user device 100 is enabled to select a resource in consideration of the given interference pattern depending on the transmission beam, so that a resource with smaller interference can be selected.

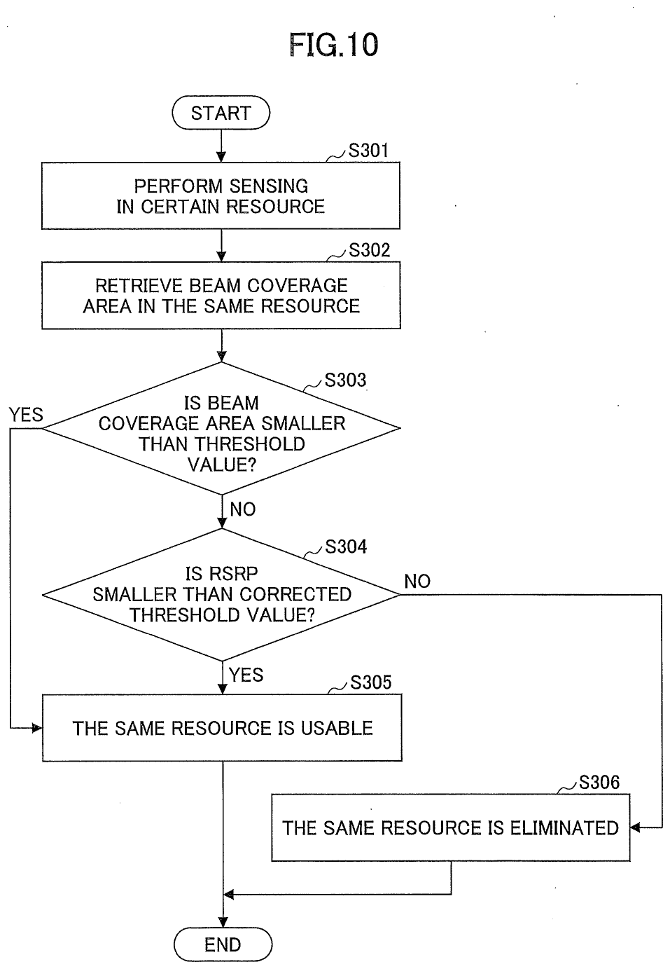

FIG. 10 is a flowchart illustrating an example (3) of resource selection in the embodiment of the present invention. FIG. 9 is a flowchart corresponding to Opt.3 described with FIG. 6. In Opt.3, the user device 100 determines whether a certain resource should be eliminated based on the beam coverage area obtained from another user device 100 and the corrected threshold value of RSRP corrected on the basis of the beam coverage area, in relation to the same resource.

In a step S301, the user device 100 performs sensing of a certain resource.

In a succeeding step S302, the user device 100 obtains a beam coverage area in a certain resource from the other closely located user device 100. The beam coverage area may be notified by use of an index of the beam coverage area indicated in Table 1.

In a succeeding step S303, the user device 100 determines whether the beam coverage area is smaller than a threshold value. The threshold value for determination of the beam coverage area may be determined or predetermined.

If the beam coverage area is smaller than the threshold value (yes in S303), the flow proceeds to a step S305. The same resource is made usable. If the beam coverage area is equal to or larger than the threshold value, the flow proceeds to a step S304.

In the succeeding step S304, the user device 100 determines whether RSRP of the same resource is smaller than a corrected threshold value.

If RSRP is smaller than the corrected threshold value (yes in S304), the flow proceeds to the step S305. The same resource is made usable. If RSRP is equal to or larger than the corrected threshold value, the flow proceeds to a step S306. The same resource is eliminated.

In the above-described Embodiment 1, the user device 100 obtains the beam coverage area related to a beam transmitted by another user device 100 located close thereto. The user device 100 can determine whether the sensed resource should be eliminated or not according to this beam coverage area. It is possible in the user device 100 to determine correction of a threshold value of RSRP in the resource to be sensed according to this beam coverage area, or to predetermine the same. Also, correction of a threshold value of RSRP in the resource to be sensed according to a beam width prioritized at the time of transmission, namely according to the beam coverage area, may be determined or predetermined.

As described above, the user device 100 can improve utilization efficiency of a resource which another closely located user device 100 may potentially use. Specifically, resource utilization efficiency of a user device performing transmission by applying beamforming can be increased in D2D.

### Embodiment 2

Embodiment 2 is hereinafter described. Portions of Embodiment 2 different from Embodiment 1 are described. Thus, portions of Embodiment 2 not referred to particularly may be the same as those in Embodiment 1.

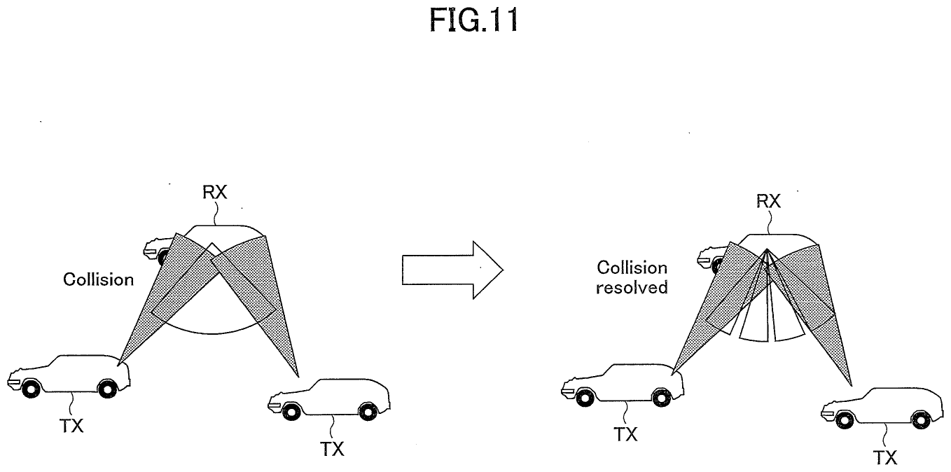

FIG. 11 is a view illustrating reception of a beam in the user device 100 in the embodiment of the present invention. As illustrated in the left side view in FIG. 11, collision of resources occurs when the user device 100 receives a beam from plural user devices 100 with a large beam width.

As illustrated on the right-side view in FIG. 11, the user device 100 performs RX beamforming to receive plural small beam widths simultaneously, so that it is possible to avoid collision of resources even upon receiving beams from plural user devices 100.

RX beamforming in which beams of plural small beam widths are received simultaneously can be determined or predetermined in the case of transmission by use of the millimeter wave band. A beam pattern can be signaled in a determined or predetermined mode. For example, information as to which of one beam pattern covering 360 degrees and four beam patterns covering respectively 90 degrees should be used can be signaled to the user device 100. This signaling can be performed based on the beam coverage area described in Embodiment 1. To be specific, it is possible to signal information of applying RX beamforming to receive plural beams of small widths in case the beam coverage area is small.

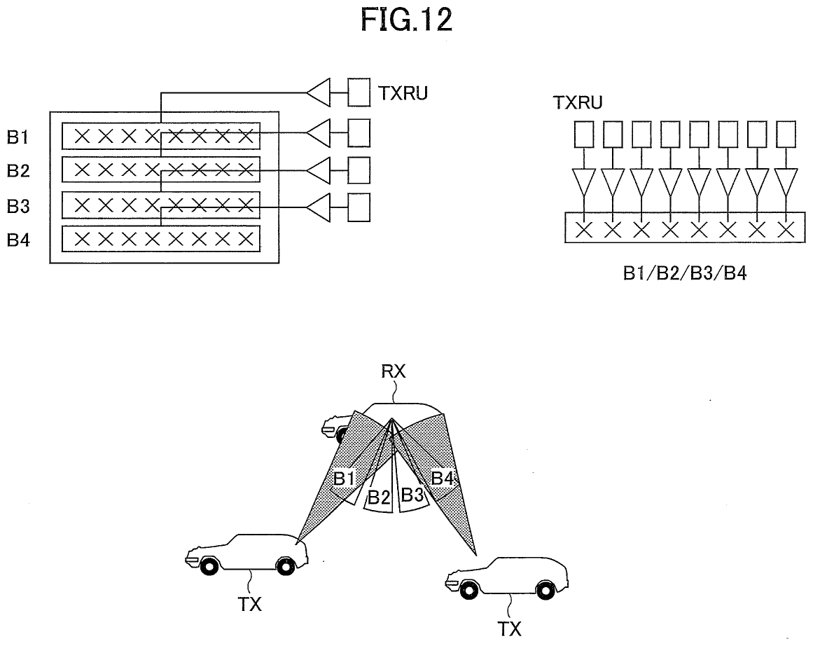

FIG. 12 is a view illustrating an example of an antenna setting for the user device 100 in the embodiment of the present invention. FIG. 12 refers to an example related to antenna setting of RX beamforming of respectively receiving the beam B1, beam B2, beam B3 and beam B4 transmitted by the transmission side TXRU (remote units).

In Embodiment 2 described above, the user device 100 can avoid collision of resources by performing RX beamforming of simultaneously receiving beams of plural small beam widths, even in reception of beams from plural user devices 100. Specifically, resource utilization efficiency of the user device performing transmission by applying beamforming can be increased in D2D.

(Device Configuration)

An example of configuring the functions of the user device 100 executing the process and operation described heretofore is described next. The user device 100 includes at least the functions for implementing the embodiments. However, the user device 100 may include only part of the functions in the embodiments.

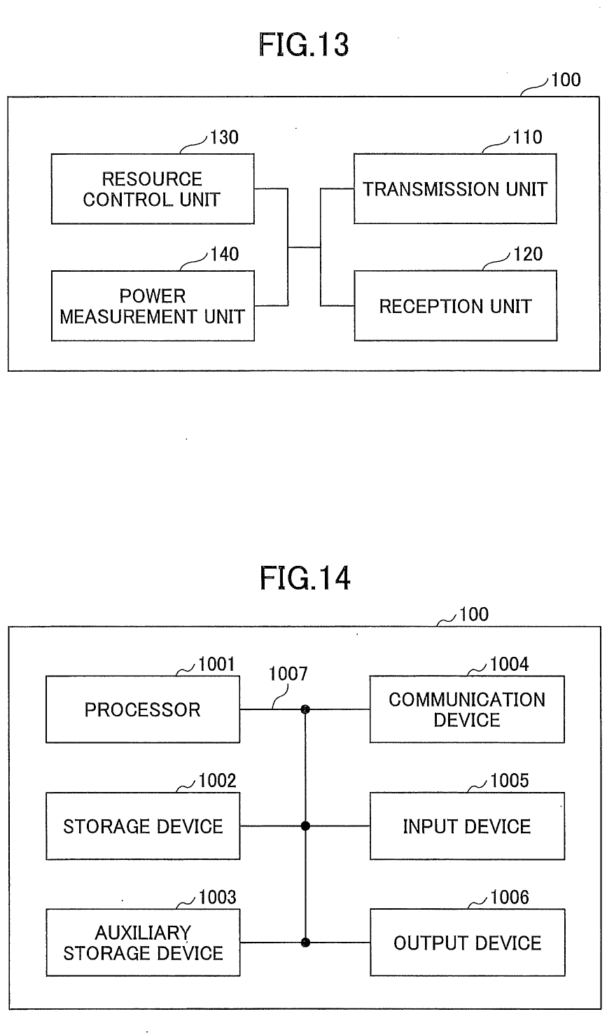

FIG. 13 is a diagram illustrating an example of functional arrangement of the user device 100. As illustrated in FIG. 13, the user device 100 has a transmission unit 110, a reception unit 120, a resource control unit 130 and a power measurement unit 140. The functional arrangement illustrated in FIG. 13 is only an example. Division of the functions and names of functional units can be determined optionally so that tasks related to the embodiments of the present invention can be performed.

The transmission unit 110 creates a signal for transmission from data for transmission, and wirelessly transmits this signal for transmission. The reception unit 120 wirelessly receives signals of various types, and obtains signals of higher layers from signals of received signals of the physical layer. The reception unit 120 has functions for receiving a synchronization signal, control signal, data and the like transmitted by the user device 100. Also, the transmission unit 110 transmits data or a control signal to another user device 100. The reception unit 120 receives data or a control signal from the other user device 100. The transmission unit 110 may perform transmission by application of beamforming.

As described in the embodiments, the resource control unit 130 selects a resource for use in transmission on the basis of information detected by performing sensing in the reception unit 120 or information obtained by signaling. Also, the resource control unit 130 obtains explicit information included in the sensing signal for selecting a resource.

As described in the embodiments, the power measurement unit 140 performs control related to measuring power of the received signal, strength of the received signal or the like in the user device 100. It is noted that functional units related to transmitting a signal or the like in the resource control unit 130 or the power measurement unit 140 may be included in the transmission unit 110, and that functional units related to receiving a signal or the like may be included in the reception unit 120.

(Hardware Configuration)

The functional arrangement diagram (FIG. 13) used for describing the above-described embodiments of the present invention illustrates blocks in units of functions. These functional blocks (components) are implemented by any combination of hardware and/or software. Furthermore, means for implementing each functional block is not particularly limited. Namely, each functional block may be implemented by a single device that is physically and/or logically coupled, or may be implemented by plural devices obtained by directly and/or indirectly (e.g., by wire and/or wirelessly) connecting the two or more devices separated physically and/or logically.

For example, the user device 100 in any one embodiment of the present invention may function as a computer for performing processes related to the embodiments according to the present invention. FIG. 14 is a diagram illustrating a hardware configuration of the user device 100 according to the embodiments of the present invention. The above-described user device 100 may be physically configured as computers, each including a processor 1001, a storage device 1002, an auxiliary storage device 1003, a communication device 1004, an input device 1005, an output device 1006, a bus 1007 and the like.

Note that, in the following description, the term “device” may be replaced with a circuit, apparatus, unit and the like. The hardware configuration of each of the user device 100 may be configured to include one or more of the respective devices illustrated in the figures and denoted at 1001-1006, or may be configured without including a part of the devices.

The respective functions in the user device 100 are realized by reading predetermined software (programs) on hardware such as the processor 1001, the storage device 1002 and the like, performing calculation in the processor 1001, and controlling communication in the communication device 1004 and reading and/or writing of data in the storage device 1002 and the auxiliary storage device 1003.

For example, the processor 1001 causes an Operating System to operate so as to control the entire computer. The processor 1001 may be formed of a central processing unit (CPU: Central Processing Unit) including an interface with a peripheral device, control device, arithmetic unit, register, and the like.

Furthermore, the processor 1001 reads a program (program code), software module, or data from the auxiliary storage device 1003 and/or the communication device 1004 to the storage device 1002, and executes various processes in accordance with these. As the program, a program is used that is for causing a computer to execute at least a part of the operation described in the embodiments above. For example, the transmission unit 110, the reception unit 120, the resource control unit 130 and the power measurement unit 140 in the user device 100 illustrated in FIG. 13 may be implemented by a control program stored in the storage device 1002 and executed by the processor 1001. It is described that the above-described various processes are performed by the single processor 1001, but may be simultaneously or sequentially performed by two or more processors 1001. The processor 1001 may be implemented by one or more chips. Note that the program may be transmitted from a network through an electrical communication line.

The storage device 1002 is a computer readable recording medium, and may be formed of, for example, at least one of a ROM (Read Only Memory), EPROM (Erasable Programmable ROM), EEPROM (Electrically Erasable Programmable ROM), RAM (Random Access Memory) and the like. The storage device 1002 may be referred to as a register, cache, main memory (main storage device) and the like. The storage device 1002 can store a program (program code), a software module and the like executable for performing processing according to the embodiment of the present invention.

The auxiliary storage device 1003 is a computer readable recording medium, and can be formed of, for example, at least one of an optical disc such as a CD-ROM (Compact Disc ROM), hard disk drive, flexible disc, magneto-optical disk (for example, compact disk, digital versatile disk, and Blu-ray (registered trademark) disk), smart card, flash memory (e.g., card, stick and key drive), floppy (registered trademark) disk, magnetic strip, and the like. The auxiliary storage device 1003 may be referred to as an auxiliary storage device. The above-described storage medium may be, for example, a database, server, or any other appropriate medium, including the storage device 1002 and/or the auxiliary storage device 1003.

The communication device 1004 is hardware (transmission/reception device) for executing communication between computers through a wired and/or wireless network, includes at least an antenna for radio communication, and is also referred to as, for example, a network device, network controller, network card, communication module, and the like. For example, the transmission unit 110 and the reception unit 120 in the user device 100 may be implemented by the communication device 1004.

The input device 1005 is an input device for receiving an input from the outside (e.g., a keyboard, mouse, microphone, switch, button, sensor and the like). The output device 1006 is an output device for implementing an output to the outside (e.g., a display, speaker, LED lamp and the like). Note that the input device 1005 and the output device 1006 may be configured to be integrated (for example, a touch panel).

Furthermore, the respective devices, such as the processor 1001 and the storage device 1002, are connected by the bus 1007 for communication of information. The bus 1007 may be formed of a single bus, or may be formed of different buses among the devices.

Furthermore, the user device 100 may be constituted to include hardware, such as a microprocessor, digital signal processor (DSP: Digital Signal Processor), ASIC (Application Specific Integrated Circuit), PLD (Programmable Logic Device), FPGA (Field Programmable Gate Array), and the like. By the hardware, a part of or all of the functional blocks may be implemented. For example, the processor 1001 may be implemented by at least one of these hardware components.

### Conclusion of the Embodiments

As has been described heretofore, according to the embodiments of the present invention, a user device for performing communication in which beamforming is applied with another user device is provided, including a reception unit configured to receive information related to a region covered by a beam with respect to a certain resource from another user device, a selection unit configured to select the resource based on information representing the region covered by the beam, and a transmission unit configured to perform transmission by using the selected resource.

According to the above configuration, the user device can eliminate a resource in consideration of the beam width of another user device by obtaining a beam coverage area from the other user device and selecting the resource. Specifically, resource utilization efficiency of the user device performing transmission by applying the beamforming can be increased in D2D.

The selection unit may eliminate the resource from resource candidates for selection in case an extent of the region represented by the information related to the region covered by the beam is equal to or larger than a first threshold value. Owing to this configuration, by eliminating the resource if a beam coverage area obtained from the other user device is large, the user device can select another resource if a width of a beam transmitted by the corresponding other user device is small.

The selection unit may measure received power by sensing a resource, and eliminate the sensed resource from resource candidates for selection in case the received power is equal to or larger than a second threshold value, and the second threshold value may be corrected based on the information representing the region covered by the beam. Owing to this configuration, the user device can correct the RSRP threshold value of the sensed resource according to the beam coverage area obtained from the other user device.

The second threshold value may be corrected to be smaller, as the region represented by the information related to the region covered by the beam becomes larger. Owing to this configuration, the user device eliminates a resource by correcting the threshold value of RSRP of the sensed resource with a decrease according to the largeness of a beam coverage area obtained from the other user device. Thus, probability with which a resource with a lower interference level can be selected becomes increased in the peripheral user device.

The second threshold value may be corrected based on information related to a region covered by a beam transmitted by the transmission unit. Owing to this configuration, the user device can control the resource to be eliminated by changing the threshold value of RSRP for sensing according to the beam width of the beam of transmission.

The reception unit may perform reception beamforming based on the information related to the region covered by the beam. Owing to this configuration, the user device can simultaneously receive beams from a plurality of other user devices without collision of resources, by performing reception beamforming according to the beam coverage area obtained from the other user device.

### Supplement to the Embodiments

The embodiments of the present invention have been described above; however, the disclosed invention is not limited to the embodiments, and a person ordinarily skilled in the art will appreciate various variations, modifications, alternatives, replacements and the like. Specific examples of numerical values are used in the description in order to facilitate understanding of the invention, but these numerical values are merely examples, and any appropriate values may be used, unless otherwise indicated. Divisions of the described items in the above description are not essential to the present invention. Depending on necessity, subject matter described in two or more described items may be combined and used, and subject matter described in a described item may be applied to subject matter described in another described item (unless contradicted). A boundary of a functional unit or a processor in the functional block diagrams may not necessarily correspond to a boundary of a physical component. An operation by a plurality of functional units may be physically executed by a single component, or an operation of a single functional unit may be physically executed by a plurality of components. In the sequence charts described in the embodiments, the order can be changed reversely, unless a contradiction arises. For the convenience of description, the user device 100 is described by using the functional block diagrams; however, such devices may be implemented in hardware, software, or combinations thereof. Each of the software to be operated by the processor included in the user device 100 in accordance with the embodiments of the present invention, and the software to be operated by the processor included in the user device 100 in accordance with the embodiments of the present invention may be stored in any appropriate storage medium, such as a random access memory (RAM), flash memory, read-only memory (ROM), EPROM, EEPROM, register, hard disk drive (HDD), removable disk, CD-ROM, database, server and the like.

Notification of information is not limited to the aspects/embodiments described in this specification, and may be given by any other methods. For example, the notification of information may be performed by physical layer signaling (for example, Downlink Control Information (DCI), Uplink Control Information (UCI)), higher layer signaling (for example, Radio Resource Control (RRC) signaling, Medium Access Control (MAC) signaling, broadcast information (Master Information Block (MIB), System Information Block (SIB))), other signals, or a combination thereof. Further, the RRC signaling may be referred to as an RRC message and may be, for example, an RRC connection setup message, an RRC connection reconfiguration message, or the like.

Each of aspects/embodiments described in the present specification may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), a system using other appropriate systems, and/or a next generation system expanded based on these systems.

The processing procedures, the sequences, the flowcharts and the like of the respective aspects/embodiments described in this specification may be reversed in order unless there is a contradiction. For example, the method described in this specification presents elements of various steps in an exemplary order and is not limited to a presented specific order.

The user device 100 can be also referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

The terms “determining” and “deciding” used in this specification may include a wide variety of actions. For example, “determining” and “deciding” may include events in which events such as judging, calculating, computing, processing, deriving, investigating, looking up (for example, looking up in a table, a database, or another data structure), or ascertaining are regarded as “determining” or “deciding.” Further, “determining” and “deciding” may include events in which events such as receiving (for example, receiving information), transmitting (for example, transmitting information), input, output, or accessing (for example, accessing data in a memory) are regarded as “determining” or “deciding.” Further, “determining” and “deciding” may include events in which events such as resolving, selecting, choosing, establishing, or comparing are regarded as “determining” or “deciding.” In other words, “determining” and “deciding” may include events in which a certain operation is regarded as “determining” or “deciding.”

As used in the present specification, the phrase “based on” does not mean “based only on” unless explicitly stated otherwise. In other words, the phrase “based on” means both “based only on” and “based on at least”.

As long as the terms “including”, “comprising”, and variations thereof are used in the specification or claims, these terms are intended to be inclusive in a manner similar to the term “comprising”. Furthermore, it is intended that the term “or” used in the specification or claims is not an “exclusive OR”.

In the entirety of the present disclosure, if an article is added by translation, for example a, an and the in English, the elements with those articles can encompass a plurality of elements, unless otherwise indicated apparently in the context.

It is noted in the embodiments of the present invention that the resource control unit 130 or the power measurement unit 140 is one example of the selection unit. A beam coverage area is one example of information related to a region covered by a beam.

Although the present invention is described in detail heretofore, it is apparent to those skilled in the art that the present invention is not limited to the embodiment described in this specification. The present invention can be implemented as a modified and changed form without deviating from the spirit and scope of the present invention defined by the claims. Accordingly, the description of the present specification is given solely by way of illustration and does not have any restrictive meaning to the present invention.

### LIST OF REFERENCE SYMBOLS

100 user device
110 transmission unit
120 reception unit
130 resource control unit
140 power measurement unit
1001 processor
1002 storage device
1003 auxiliary storage device
1004 communication device
1005 input device
1006 output device

1. A user device for performing communication in which beamforming is applied with another user device, the user device comprising:
a reception unit that receives information related to a region covered by a beam with respect to a certain resource from another user device;
a selection unit that selects the resource based on information representing the region covered by the beam; and
a transmission unit that performs transmission by using the selected resource.

2. The user device as claimed in claim 1, wherein the selection unit eliminates the resource from resource candidates for selection when a size of the region represented by the information related to the region covered by the beam is equal to or larger than a first threshold value.

3. The user device as claimed in claim 1, wherein the selection unit measures received power by sensing a resource, and eliminates the sensed resource from resource candidates for selection when the received power is equal to or larger than a second threshold value, and
wherein the second threshold value is corrected based on the information representing the region covered by the beam.

4. The user device as claimed in claim 3, wherein the second threshold value is corrected to be smaller, as the region represented by the information related to the region covered by the beam becomes larger.

5. The user device as claimed in claim 4, wherein the second threshold value is corrected based on information related to a region covered by a beam transmitted by the transmission unit.

6. The user device as claimed in claim 1, wherein the reception unit performs reception beamforming based on the information related to the region covered by the beam.
